(19) United States
(12) Patent Application Publication
(10) Pub. No.: US 2023/0375513 A1
(43) Pub. Date: Nov. 23, 2023

(54) METHOD AND ELEMENTAL ANALYZER FOR ORGANIC AND INORGANIC SAMPLES

(71) Applicant: VELP SCIENTIFICA SRL, Usmate Velate (IT)

(72) Inventor: Giovanni Passoni, Usmate Velate (IT)

(21) Appl. No.: 18/029,175

(22) PCT Filed: Oct. 6, 2021
(86) PCT No.: PCT/IB2021/059149

§ 371 Date: Mar. 29, 2023

(30) Foreign Application Priority Data
Oct. 7, 2020 (IT) 102020000023584

(51) Int. Cl. G01N 31/12; G01N 21/65

(52) U.S. Cl. CPC G01N 31/12; G01N 21/65

(57) ABSTRACT

An apparatus (10) for elemental analysis of a sample (12), comprising a chamber (11) for heat treatment of the sample for emission of gaseous products from the decomposition (for example combustion or pyrolysis) of said sample, an analysis zone (14) which receives the gaseous products and a Raman effect spectroscopic device (15) for analysis of the gaseous products present in the said analysis zone. The analysis zone may be contained inside a second chamber (22). An analysis method is also described.

The present invention relates to an innovative elemental analyzer which is fast, precise and efficient, intended for the analysis of organic or inorganic samples. The invention also relates to an analysis method.

The elemental analysis or qualitative analysis of the elements has the purpose of establishing the elements which are present in the organic or inorganic compound being examined and estimating the quantity thereof. Apparatus for this type of analysis are for example used as analysis apparatus in quality control or in research and development.

In the sector relating to the elemental analysis of organic samples the Dumas method is well known, being based on the determination of the quantity of nitrogen produced by a process for the controlled combustion of the material undergoing analysis. This allows for example the analysis of the proteins in organic substances since it is possible to determine the quantity of proteins on the basis of the percentage of nitrogen detected at the end of the analysis. In automatic Dumas analyzers, usually the sample is inserted inside a high-temperature controlled-atmosphere combustion chamber. In general a pure oxygen atmosphere and a temperature of around 1000° C. are used. Combustion products containing nitrogen, in the form of different oxides, and carbon dioxide and water, are thus generated. These combustion products are made to pass through a special reduction chamber which contains granules of copper heated to a temperature higher than 600° C. The contact with the copper removes from the mixture the excess oxygen and converts the nitrogen oxides into elemental nitrogen. The reduction chamber is followed by special chemical/physical traps which remove the residual water and the carbon dioxide. The gas thus purified finally reaches a dedicated sensor (generally formed with a thermal conductivity detector) which measures the total nitrogen content.

From the quantity of nitrogen detected it is then possible for example to calculate the quantity of proteins which were contained in the initial sample which was burned.

In a Dumas analyzer, by means of the traditional process it is possible basically to measure only the nitrogen, removal of the other combustion compounds being necessary in order to allow correct detection by the dedicated sensor. Moreover, purification of the combustion products before the gas reaches the sensor is a critical and somewhat delicate aspect for the measurement precision of the sensor. Both for determination of the nitrogen and, where necessary, of the carbon, it is necessary to use always systems which eliminate the interfering gases, using reactants which must be periodically replaced.

For example, the copper and the chemical-physical traps deteriorate with use and this may result in a gradual deterioration in the quality of the final measurement.

In some cases the determination of other elements, including sulphur, hydrogen, oxygen or carbon, would also be of interest. This is generally done by using suitable infrared sensors or specific colorimetric, UV fluorescence or X-ray techniques. This complicates significantly the analyses.

If it is required to examine several combustion gas elements, it is also often necessary to use a specific identifier for each element and this complicates even more the analysis and limits the analytical capacities of the known machines.

The use of other analysis methods, such as the use of chromatography columns, allows the separation of the various gaseous components, but it is necessary to use few mg of sample or a representative quantity of the gases developed before transfer into the column must be sampled. These operations may be complex and must be carefully performed, otherwise incorrect values in the analysis may occur. This results in the need for specifically qualified personnel and is relatively time-consuming.

In any case. the elemental analysis systems are therefore unsatisfactory.

The general object of the present invention is to provide an innovative elemental analyzer apparatus for organic or inorganic samples.

In view of this object the idea which has occurred is to provide, according to the invention, an apparatus for elemental analysis of a sample, comprising a chamber for heat treatment of the sample so as to cause the emission of gaseous products from this sample, an analysis zone which receives the gaseous products and a Raman effect spectroscopic device for analysis of the gaseous products present in the said analysis zone.

Again in view of this object, the idea which has occurred is to provide a method for elemental analysis of a sample, comprising the steps of causing the emission of gaseous products from the sample in a heat treatment chamber and analyzing with Raman effect spectroscopy the gaseous products emitted by the sample following the heat treatment.

In particular, the heat treatment of the sample may advantageously consist of combustion or pyrolysis.

In order to illustrate more clearly the innovative principles of the present invention and its advantages compared to the prior art, an example of embodiment applying these principles will be described below with the aid of the attached drawings. In the drawings:

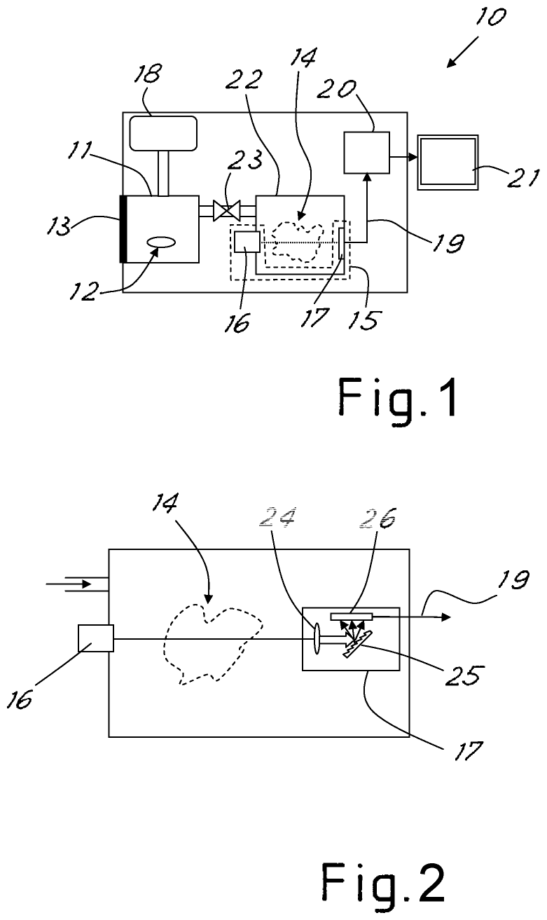

FIG. 1 shows a schematic view of an apparatus for elemental analysis of a sample provided in accordance with the principles of the invention;

FIG. 2 shows a schematic view of a possible variation of embodiment of a part of the apparatus according to FIG. 1.

With reference to the figures, FIG. 1 shows an apparatus provided in accordance with the invention and denoted generally by 10.

This apparatus 10 comprises a chamber 13 for heat treatment of an organic or inorganic sample 12 which must be analyzed. The heat treatment chamber is of the type suitable for causing the emission of gaseous products from the sample following the heat treatment carried out on the sample. In particular, the heat treatment will decompose the sample into gaseous products (molecules or atoms).

In particular, the heat treatment may advantageously consist of combustion or pyrolysis of the sample, with the heat treatment chamber 11 which in this case is a combustion chamber or a pyrolysis chamber. In general, the sample will be a solid or liquid sample. For introduction of the sample into the chamber a hatch 13 which sealingly closes the chamber 11 may be provided.

While the combustion may take place in the presence of a suitable comburent or oxidising agent (for example oxygen), pyrolysis (or “pyroscission”) is a thermochemical decomposition process which may be easily obtained by means of the application of heat and in complete absence of an oxidising agent. In this way it is not necessary to introduce oxygen for the combustion and it is possible to measure also the oxygen produced by the sample, if required. In order to prevent the interference of the atmospheric oxygen, a source 18 of an inert gas (advantageously argon or helium for example) may be provided, this being introduced into the heat treatment chamber before starting the pyrolysis in order to expel the air present and perform the pyrolysis in an inert atmosphere. However, in the case where it is not required to measure the oxygen, it is possible to perform combustion under atmospheric conditions, also enriched with oxygen, or in the presence of pure oxygen.

In any case it has been found to be advantageous if the heat treatment chamber causes decomposition of the sample at a temperature preferably higher than 800° C. and in particular preferably between 900 and 1800° C.

The apparatus comprises an analysis zone 14 which receives the gaseous molecules emitted by the sample in the chamber 11 following the aforementioned decomposition heat treatment.

The transfer to the analysis zone may also be performed using a gaseous flow, for example produced by the inert gas (e.g. argon and/or helium) source 18.

A Raman effect spectroscopic device 15 acts in the analysis zone 14 for the analysis of the gaseous products present in the said analysis zone.

As is known, the Raman effect is obtained by subjecting the gaseous products (molecules or atoms) to an intense electromagnetic radiation (generally a strong monochromatic light). Most of the radiation is dispersed at the same wavelength as the incident radiation in a process known as Rayleigh scattering. However, a small fraction, about one photon per million, is dispersed at a wavelength different from that of the original wavelength, resulting in what may be defined as being a Raman spectrum. Since different molecules or atoms result in a different dispersion of wavelengths and the intensity of the diffused light is proportional to the quantity of material present, by reading the dispersion it is possible to determine which molecules or atoms they have generated and estimate the relative quantity thereof.

The device 15 therefore comprises a per se known source 16 of sufficiently strong and preferably monochromatic, electromagnetic radiation which crosses the analysis zone 14, and a per se known sensor 17 for detecting the intensity of the radiation at the different wavelengths of interest, which is diffused by the gaseous products present in the analysis zone 14 and excited by the electromagnetic source.

Advantageously, the source of electromagnetic radiation is a laser of suitable wavelength and power. In particular, the wavelength may be preferably between 400 nm and 800 nm. For example, the typical wavelengths may be 780 nm, 633 nm, 532 nm and 473 nm.

The power of the source may be preferably between 1 mW and 100 mW. In particular it may be preferably not greater than 50 mW.

The source may also perform emission at several wavelengths (simultaneously or also in sequence in order to simplify the task of the sensor) so as to allow different or more complete elemental analyses.

In any case, the intensity of the Raman dispersion is proportional to 1/λ⁴, and therefore the shorter wavelengths provide a stronger Raman signal. This would suggest collecting the whole of the Raman signal using lasers with a shorter wavelength; however in these conditions there is much more likelihood of the phenomenon of fluorescence occurring and an intense fluorescence could saturate the sensor and make the Raman effect measurements impossible or problematic.

The fluorescence, however, depends on the excitation wavelength and therefore for example a molecule which is fluorescent at a certain wavelength is less likely to be so at another higher wavelength, thus eliminating the problem. For this reason it is possible to choose a wavelength which achieves a balance between the two effects, also depending on the molecules which are to be analyzed.

The Raman signal is in any case very weak and, in order to obtain a spectrum with a good ratio between signal and noise, it is preferable to have high energy incident at a low wavelength (e.g. 532 nm—green colour) and a system for concentration of the rays.

In any case, once the sensor 17 has detected the dispersion due to the Raman effect, the signal 19 of the sensor may be processed by a per se known processing system 20 (for example with a suitably programmed microprocessor), in order to determine the composition of the gaseous products from the Raman dispersion detected, using a processing process known per se to the person skilled in the art. The result may be shown by an output interface 21 (for example a monitor or a printer).

The detection sensor 17 advantageously may comprise a detector having an area for measuring the intensity of the light falling in spatially separated zones of this measurement area and an optical system (for example, advantageously a prism or a diffraction grating), per se essentially known, which decomposes spatially the diffused light depending on the wavelength, so that the light at different wavelengths falls into different zones of the measurement area and therefore its intensity is established by the detector.

Although it may be envisaged that the analysis zone receives the gaseous products to be analyzed as a stream passing through the analysis zone, it may be advantageous for analysis to take place in static conditions, namely with the gaseous products kept inside a closed chamber in the analysis zone.

The analysis zone may therefore have fluid-tight closure means. Moreover it may also be envisaged that the analysis zone is placed under pressure for the analysis, for example by introducing an inert gas, in order to increase the detection sensitivity of the apparatus.

In such a case, the pressure may be advantageously greater than 2 atmospheres and preferably greater than or equal to 4 atmospheres. A pressure range of between 2 and 5 atmospheres may be advantageous.

The analysis zone 14 may be advantageously contained in a second chamber 22 interconnected to the first chamber 11 for transfer of the gaseous products from the first chamber to the second chamber and for their analysis inside the second chamber. The passage between the first chamber 11 and the second chamber 22 may be advantageously provided so as to be re-closable, for example by means of a suitable valve 23. This allows also easier pressurization of the analysis zone, if desired.

A special gaseous flow between the first and second chambers may act as a carrier and facilitate the transportation of the gaseous products to be examined between the first chamber and the second chamber. The source 18 for the introduction of inert gas into the first chamber may for example produce this flow.

If a greater sensitivity should be required a bigger measurement chamber 22 could be used. Upon arrival of the gas flows, the carrier pushes the gases inside the chamber 22, increasing the pressure, for example up to 4-5 atm, and then closes the entry valve 23. Acquisition of the signal is started for a certain time period, for example 30-60 seconds, then the chamber 22 is emptied via a special discharge outlet (not shown). The chamber(s) may then be cleaned by means of the inert gas flow and the apparatus is ready for a new analysis.

The advantage of a “closed chamber” method is a possible increase in sensitivity (the residence time of the gases to be analyzed in the analysis zone may be increased if need be).

The temperature of the analysis zone may also be preferably regulated at a temperature of between −40 and +200° C., preferably about 40-60° C. The use of a second chamber 22 may facilitate the temperature-regulation of the analysis zone.

FIG. 2 shows in schematic form a possible advantageous embodiment of the Raman analysis device 15 of the apparatus according to the invention. In this embodiment, the electromagnetic radiation emitted by the source 16, after passing through the analysis zone 14 and being diffused by the Raman effect, is concentrated by an optical system 24 (for example a lens system) and sent to a diffraction grating 25, arranged between the analysis zone and the detector 25, for spatial decomposition and conveying thereof to the measurement area of the detector 25 depending on the wavelength. The detector 24 may be advantageously a known CCD sensor with suitable sensitivity and spatial resolution for the desired sensitivity of the analysis apparatus. The CCD sensor will thus send signals 19 depending on the wavelength and the intensity of the diffused radiation and, in practice, depending on the nature of the gaseous products present in the analysis zone 14. The signal 19 may be integrated and processed by the processing unit 20.

At this point it is clear how the objects of the invention have been achieved.

With the analysis method and the analysis apparatus according to the invention, it is possible to determine easily the characteristics of an organic or inorganic sample, by analyzing several elements produced by the heat treatment designed to cause the emission of gaseous products from the sample (advantageously by means of combustion or pyrolysis of the sample).

Being able to detect simultaneously all the Raman signals of the gaseous products of interest generated during the heat treatment as mentioned above, it is possible to simplify significantly the structure of an elemental analyzer apparatus for organic/inorganic samples.

For example, after combustion of the sample, a catalyst for reducing the nitrogen oxide to elemental nitrogen is not required. Furthermore, it is not required to retain the water generated since this molecule may also be quantified.

It is not even necessary to remove the excess oxygen, for example with the copper, since the oxygen has an independent peak, which may also be used to check its correct dosage during combustion.

It is also not necessary for the carbon dioxide to be eliminated before measurement because it may be easily determined using two peaks of similar intensity.

Any sulphur dioxide present is also quantified simultaneously.

The chlorine which is present (usually in the form of HCl) is quantifiable and must not be necessarily removed before the measurements.

The same is true for determination of the oxygen in the form of CO or CO₂ or hydrogen, developed for example by high-temperature pyrolysis.

In reducing conditions it is also possible, if necessary, to detect a series of molecules such as H₂S, NH₃, PH₃.

This therefore constitutes a major advantage compared to the current methods, with furthermore a reduction in the complexity of the apparatus required.

Obviously the description given above of embodiments applying the innovative principles of the present invention is provided by way of example of these innovative principles and must therefore not be regarded as limiting the scope of the rights claimed herein.

For example, the arrangement and structure of the chamber(s) may be different from that shown, and likewise the Raman effect spectroscopic measurement system may be different, as may be now imagined by the person skilled in the art on the basis of the description provided.

1. An apparatus for the elemental analysis of a sample, comprising a chamber for heat treatment of the sample for the emission of gaseous products from said sample, an analysis zone which receives the gaseous products and a Raman effect spectroscopic device for analyzing the gaseous products present in said analysis zone.

2. The apparatus according to claim 1, wherein the heat treatment chamber is a combustion chamber or a pyrolysis chamber for the sample.

3. The apparatus according to claim 1, wherein the heat treatment chamber is adapted to produce a heat treatment of the sample at a temperature higher than 800° C.

4. The apparatus according to claim 1, wherein the analysis zone receives the gaseous products as a passing stream.

5. The apparatus according to claim 1, wherein the analysis zone has fluid-tight closure means and pressurizing means for the analysis.

6. The apparatus according to claim 5, wherein the analysis zone is pressurized at a pressure greater than 2 atm and, preferably, greater than or equal to 4 atm.

7. The apparatus according to claim 1, wherein the Raman effect spectroscopic device comprises an electromagnetic source, a laser, for the excitation of the gaseous products present in the analysis zone and a sensor for detecting the intensity at different wavelengths of the light that is diffused by the gaseous products excited by the electromagnetic source.

8. The apparatus according to claim 7, wherein the detection sensor comprises a detector having an area for measuring the intensities of light falling in spatially separated areas of this measuring area and a prism or a diffraction grating arranged between the analysis zone and the detector for the spatial decomposition of the diffused light as a function of the wavelength and its transmission on the measurement area.

9. The apparatus according to claim 1, wherein said analysis zone is contained in a second chamber interconnected to the first chamber for the transfer of the gaseous products from the first chamber to the second chamber and their analysis in the second chamber.

10. The apparatus according to claim 9, further comprising a source for introducing a gaseous flow for transporting the gaseous products between the first and second chambers.

11. The apparatus according to claim 10, wherein the gaseous flow is, or contains, an inert gas, including preferably argon or helium.

12. The apparatus according to claim 7, wherein the source has a wavelength between 400 nm and 800 nm.

13. The apparatus according to claim 7, wherein the detection sensor comprises a CCD sensor.

14. The apparatus according to claim 1, wherein the analysis zone is thermostatted at a temperature between −40 and +200° C.

15. A method of elementary analysis of a sample comprising the steps of causing the emission of gaseous products from the sample in a heat treatment chamber and analyzing with Raman effect spectroscopy of the gaseous products emitted by the sample following the heat treatment.

16. The method according to claim 15, wherein the heat treatment is a combustion or a pyrolysis of the sample.

17. The method according to claim 15, wherein the heat treatment takes place at a temperature higher than 800° C.

18. The method according to claim 15, wherein the heat treatment takes place in a first heat treatment chamber and the analysis with Raman effect spectroscopy takes place in a second chamber connected to the first chamber so as to receive the gaseous products emitted by the sample.

19. The method according to claim 15, wherein the transfer of the gaseous products between the first and second chambers takes place by means of a gaseous flow which contains or is an inert gas, including argon or helium.
